(19) United States
(12) Patent Application Publication
(10) Pub. No.: US 2021/0362656 A1
(43) Pub. Date: Nov. 25, 2021

(54) Document Holder

(71) Applicant: Big Rig Bill Buddy Products Inc., Fort St. John (CA)

(72) Inventors: Colin Glen HARBIN, Spruce Grove (CA); Darren John MANSER, Kamloops (CA)

(21) Appl. No.: 17/329,688

(22) Filed: May 25, 2021

Related U.S. Application Data
(60) Provisional application No. 63/029,624, filed on May 25, 2020.

(51) Int. Cl. B60R 7/04; B60R 7/08; B42F 1/00

(52) U.S. Cl. CPC B60R 7/046; B42F 1/00; B60R 7/08

(57) ABSTRACT

A method of securing at least one document to a window involves retaining the at least one document in a retaining portion of a document holder by inserting the at least one document through an opening defined along a retaining portion side edge of the retaining portion. A length of the opening is substantially equal to a length of the retaining portion side edge. The method further involves inserting a securing portion of the document holder extending from the retaining portion into an opening defined by a windowpane of the window when the windowpane is in an open position. The method further involves, when the securing portion is inserted into the opening defined by the windowpane, moving the windowpane from the open position to a substantially closed position to engage the securing portion and thereby secure the document holder at the window.

### CROSS REFERENCE APPLICATIONS

This application is a non-provisional application claiming the benefits of provisional application No. filed 63/029,624 filed May 25, 2020, which is hereby incorporated by reference for all purposes.

### BACKGROUND

### 1. Field

This application relates generally to document holders, and specifically to document holders which secure at least one document to a window of a vehicle, a method of operation of such document holders, and a method of manufacturing such document holders.

### 2. Description of Related Art

Prior art document holders which secure a document to a window of a vehicle may be complex and difficult to manufacture, because such document holders may require a number of different components. For example, such document holders may require components for protecting the document from adverse weather conditions because such document holders are adapted to secure the document to an exterior of the window of the vehicle. Further, it may be difficult to insert and remove documents from prior art document holders which have openings that are too small, or which are covered with flaps, or which are otherwise sealed. It may also be difficult locate such document holders in a messy cab vehicle or see such document holders from far away on an exterior of a vehicle.

### SUMMARY

In one embodiment, there is provided a method of securing at least one document to a window. The method involves retaining the at least one document in a retaining portion of a document holder by inserting the at least one document through an opening defined along a retaining portion side edge of the retaining portion. A length of the opening is substantially equal to a length of the retaining portion side edge. The method further involves inserting a securing portion of the document holder extending from the retaining portion into an opening defined by a windowpane of the window when the windowpane is in an open position. The method further involves, when the securing portion is inserted into the opening defined by the windowpane, moving the windowpane from the open position to a substantially closed position to engage the securing portion and thereby secure the document holder at the window.

In another embodiment, there is provided a document holder includes a retaining portion for retaining at least one document, the retaining portion including a first retaining portion side edge, a second retaining portion side edge, and an opening defined along at least one of the first and second retaining portion side edges. A length of the opening is substantially equal to a length of the at least one first and second retaining portion side edges. The document holder further includes a securing portion extending from the retaining portion, the securing portion configured to secure the document retainer to a window when engaged by a windowpane of the window when the windowpane is in a substantially closed position.

In another embodiment, there is provided a method of manufacturing a document holder from a first sheet and a second sheet. The method involves: joining the first and second sheets at a defining line to define a securing portion of the document holder on a first side of the defining line and a retaining portion of the document holder on a second side of the defining line; forming the securing portion by joining the first and second sheet portions proximate a securing portion edge; and forming the retaining portion by joining the first and second sheet portions proximate a retaining portion bottom edge and not joining the first and second sheet portions proximate at least one of a first retaining portion side edge and a second retaining portion side edge to form an opening in the retaining portion. A length of the opening is substantially equal to a length of the at least one of the first and second retaining portion side edges.

Other aspects and features of the present disclosure will become apparent to those ordinarily skilled in the art upon review of the following description of specific embodiments of the disclosure in conjunction with the accompanying Figures.

### BRIEF DESCRIPTION OF THE DRAWINGS

In drawings which illustrate embodiments,

FIG. 1 is a perspective view of a document holder in accordance with one embodiment.

FIG. 2 is a perspective view of the document holder of FIG. 1 as it is secured to a vehicle.

FIG. 3 is a perspective view of a document holder in accordance with another embodiment.

FIGS. 4A to 4C are a perspective views of document holders including at least one visibility element in accordance with certain embodiments.

FIG. 5 is a plan view of a single unitary sheet for forming the document holder of FIG. 1.

FIG. 6 is a plan view of a system of separate first and second sheet portions for forming the document holder of FIG. 1.

FIGS. 7A to 7C are a perspective views of document holders having irregular and unusual shapes in accordance with certain embodiments.

### DETAILED DESCRIPTION

When a vehicle, such as an automobile, is transporting a shipment including hazardous materials, decals and placards indicating that the vehicle includes hazardous materials must be attached on the automobile. Further, certain documents, including dangerous goods bills of lading, associated with the hazardous material must be placed in a cab of the vehicle, such that if the automobile is in an accident or when the automobile is left unattended, a first responder or an inspector may be able to clearly ascertain the identity and the quantity of the hazardous material contained in the vehicle.

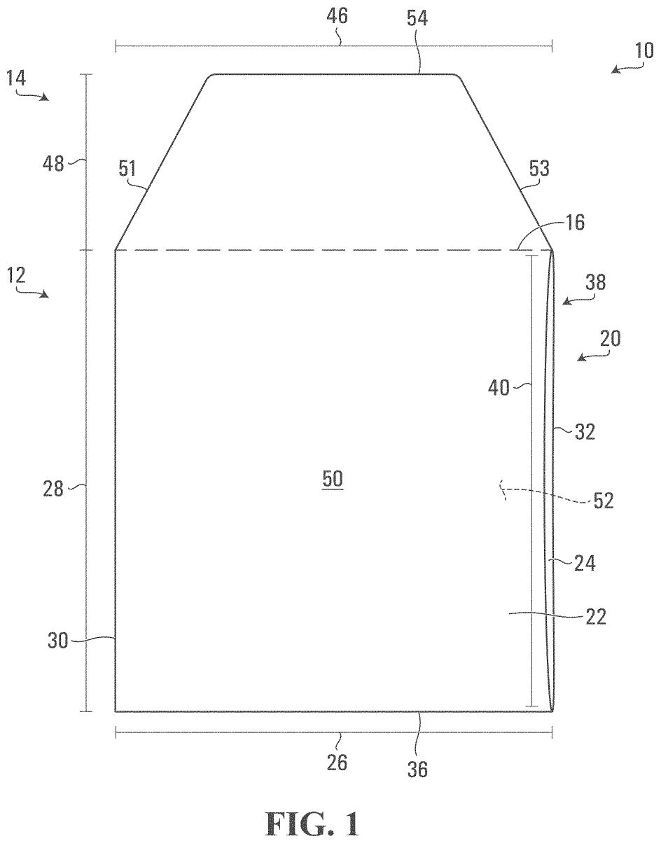

Referring to FIG. 1, a document holder according to a first embodiment is shown generally at 10. The document holder 10 includes a retaining portion 12 for retaining at least one document and a securing portion 14 extending from the retaining portion 12, the securing portion 14 configured to secure the document holder 10 to a window, such as the window of the vehicle (described in greater detail below). The retaining portion 12 and the securing portion 14 may be separated by a defining line 16. The document holder 10 may be formed from a first sheet 22 and a second sheet 24, wherein the first sheet 22 may define a first face 50 of the document holder 10 and the second sheet 24 may define a second face 52 of the document holder 10. The first and second sheets 22, 24 maybe formed of transparent material, such as clear, colored, and/or tinted plastic.

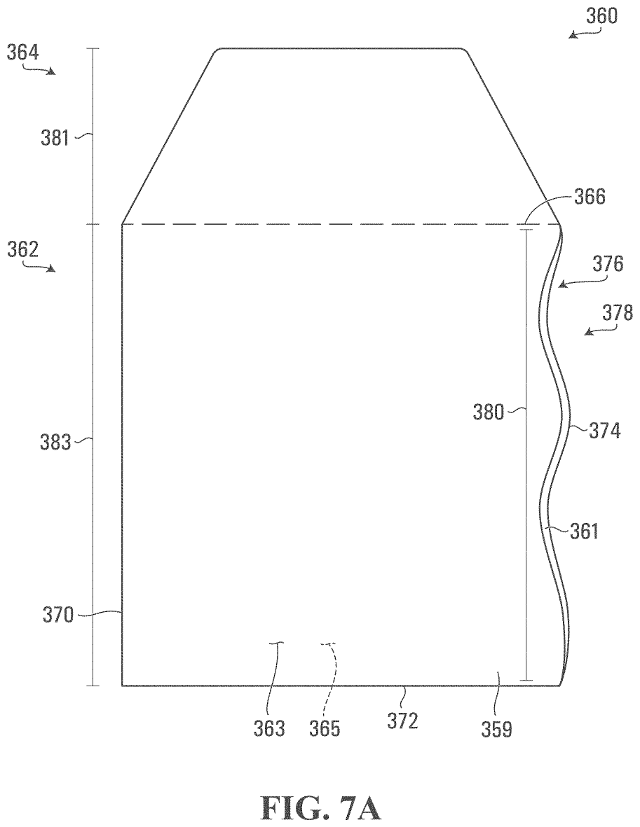

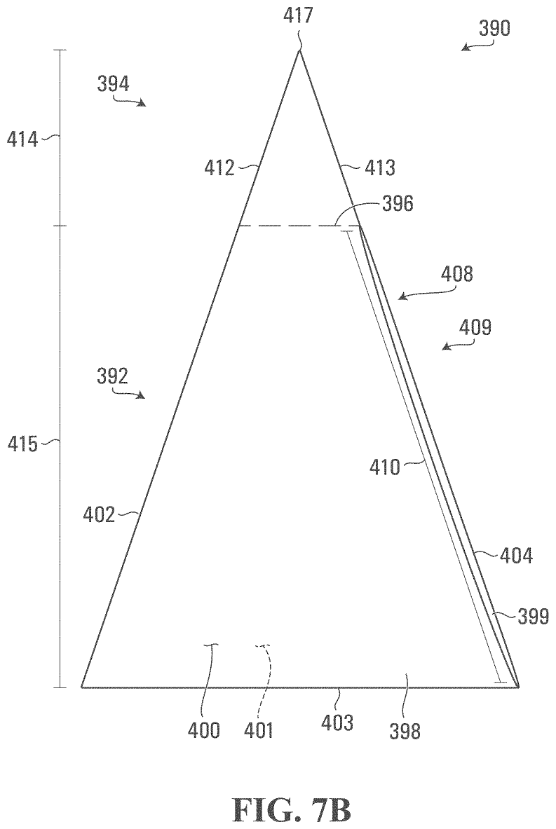

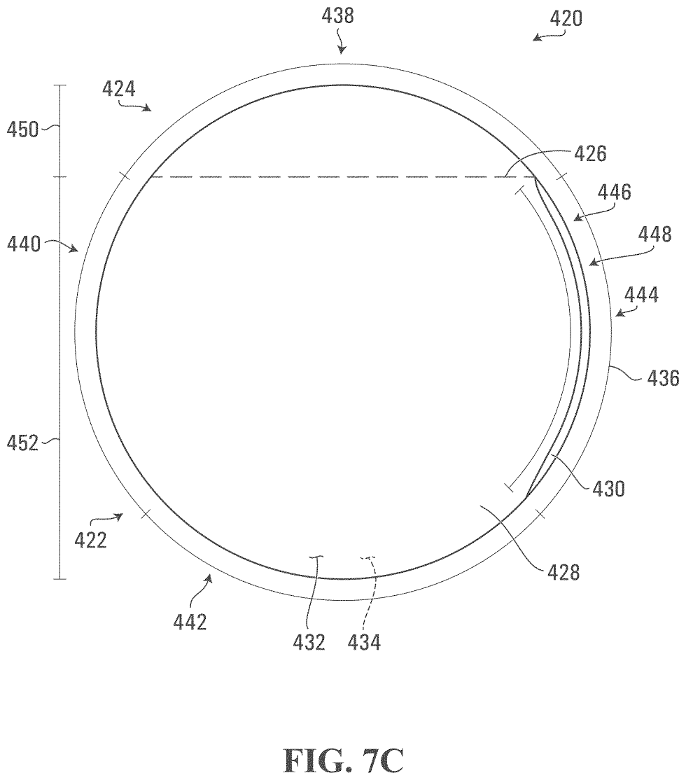

In the embodiment shown in FIG. 1, the retaining portion 12 has a substantially rectangular shape. In other embodiments, the retaining portion 12 may have another shape (as described below in association with FIGS. 7A to 7B for example). The retaining portion 12 includes a first retaining portion side edge 30, a second retaining portion side edge 32, and a retaining portion bottom edge 36. In the embodiment shown, the defining line 16 effectively defines a top edge of the retaining portion 12. In other embodiments (not shown), the top edge of the retaining portion 12 maybe spaced apart from the defining line 16.

The retaining portion 12 includes a compartment 20 for holding the at least one document. The compartment 20 may be formed by the first and second sheets 22, 24 being joined at certain locations, and in the embodiment shown in FIG. 1, may specifically be a pocket being formed by the first and second sheets 22, 24 being joined at the first retaining portion side edge 30, the retaining portion bottom edge 36 and the defining line 16. The first and second sheets 22, 24 may be joined using an adhesive, stitches, and/or welds (such as stich welds for example). The retaining portion 12 also includes an opening 38 for receiving at least one document in the compartment 20. The opening 38 may be formed by the first and second sheets 22, 24 not being joined at the second retaining portion side edge 32. In the embodiment shown in FIG. 1, the opening 38 has a length 40 that is substantially equal to a maximum height 28 of the retaining portion 12, and is defined by the entire second retaining portion side edge 32 of the document holder 10. In other embodiments, an opening of a retaining portion of a document holder may only be defined by an entire side edge of the retaining portion, but the opening may have a length which is less than or more than a maximum height of the retaining portion (see, for example, FIGS. 7B and 7C below). Having a large opening, such as an opening defined by an entire side edge of a retaining portion, or an opening having a length which is equal to a maximum height of a retaining portion, can allow a user to easily remove at least one document retained within the compartment of the retaining portion or to easily insert at least one document into the compartment of the retaining portion. Such easy insertion and removal of the at least one document which may be useful for bills of lading that are frequently changed depending on a particular type of goods are currently being transported in a vehicle. For example, a user (such as a vehicle operator) may deliver and pick up different goods at a number of locations and stops along a particular transport route, wherein each delivery or pick up may be associated with a modification to a current bill of lading or with a different bill of lading. As such, the relevant bills of lading which may need to be displayed with the vehicle may change frequently, and having a document holder with a large opening may facilitate the frequent change in display of such bills of lading. Further, a user may be extremely tired at a time which they need to display a bill of lading with the vehicle, such as at night or after a long route at a pitstop. Having a document holder with a large opening allows the user to more easily insert and remove documents from the document holder, thereby encouraging the user to more consistently and frequently use the document holder to secure at least one document to the vehicle.

In other embodiments, the compartment 20 maybe a slot formed by the first and second sheets 22, 24 being joined only at the defining line 16 and the retaining portion bottom edge 36 (and not at either the first or second retaining portion side edges 30, 32), the slot including a through hole having a first opening proximate to the first retaining portion side edge 30 and a second opening proximate to the second retaining portion side edge 32. In such embodiments, the first opening is defined by the entire first retaining portion side edge 30 and the second opening is defined entirely by the second retaining portion side edge 32.

The retaining portion 12, has a maximum width 26 (being the distance between the first retaining portion side edge 30 and the second retaining portion side edge 32) and the maximum height 28 (being the distance between the defining line 16 and the retaining portion bottom edge 36). In the embodiment shown, the maximum height 28 is greater than the maximum width 26. For example, the maximum height 28 may be 13 inches and the maximum width 26 may be 10 inches. In other embodiments, the maximum height 28 and the maximum width 26 may be equal, or the maximum height 28 may be less than the maximum width 26.

Still referring to FIG. 1, the securing portion 14 extends from the retaining portion 12 and is configured to secure the document holder 10 to a window, such as a window of the vehicle, when the securing portion 14 is engaged by the windowpane of the window when the windowpane is in a substantially closed position. In the embodiment shown, the securing portion 14 has a generally trapezoidal shape. In other embodiments, a securing portion of a document holder may have another shape (as described below in association with FIGS. 7A to 7B for example). In the embodiment shown in FIG. 1, the securing portion 14 has a first securing portion side edge 51, a second securing portion side edge 53, a securing portion top edge 54, wherein the defining line 16 effectively defines a bottom edge of the securing portion 14. However, in other embodiments, a bottom edge of the securing portion 14 may be spaced apart from the defining line 16. As noted above, the securing portion 14 is separated from the retaining portion 12 by the defining line 16.

In the embodiment shown in FIG. 1, the securing portion 14 may be formed of both the first and second sheets 22, 24 joined at a certain locations, such as along the first securing portion side edge 51, the second securing portion side edge 53, the securing portion top edge 54, and the defining line 16, to form a unitary securing portion 14. In other examples, the first and second sheets 22, 24 may be joined at more or fewer locations, such as only along the securing portion top edge 54 and the defining line 16. In yet other embodiments, the securing portion 14 may be formed from a single one of the first and second sheets 22, 24. For example, one of the first and second sheets 22, 24 may include a portion extending beyond the other one of the first and second sheets 22, 24 to form the securing portion 14 and the other one of the first and second sheets 22, 24 only extends to the defining line 16 to form the retaining portion 12.

In the embodiment shown in FIG. 1, the securing portion 14 has a maximum width 46 being measured from a widest portion of the securing portion 14 (generally being a length of the defining line 16 in the embodiment shown), and a maximum height 48 (generally being a distance between the defining line 16 and the retaining portion bottom edge 36). Generally, the securing portion 14 is sized to be easily and quickly engaged by the windowpane when the windowpane is in a substantially closed position. In certain embodiments, the maximum height 48 of the securing portion 14 may be in at least one fourth of the maximum height 28 of the retaining portion 12. For example, if the maximum height 28 of the retaining portion 12 is approximately 13 inches, the maximum height 48 of the securing portion 14 may be at least approximately 3.25 inches. In other embodiments, the maximum height 48 of the securing portion 14 may be at least one half of the maximum height 28 of the retaining portion 12. For example, if the maximum height 28 of the retaining portion 12 it is approximately 13 inches, the maximum height 48 of the securing portion 14 may be at least approximately 6.5 inches.

The document holder 10 that may be substantially reversible, such that the first face 50 of the document holder 10 defined by the first sheet 22 maybe substantially identical to the second face 52 of the document holder 10 defined by the second sheet 24.

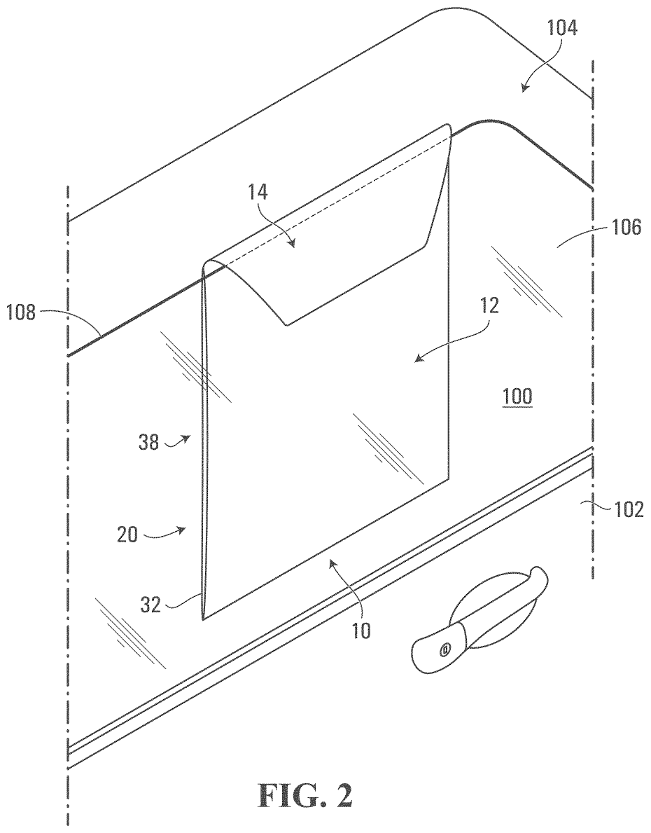

Referring now to FIG. 2, utilizing the document holder 10 to secure at least one document, such as a dangerous goods bills of lading, to a window 100 of a vehicle 102 will now generally be described. In the embodiment shown, the vehicle may be an automobile. In other embodiments, the vehicle may be a train, or the window 100 may further be windows of houses or residences.

A user may first retain at least one document in the retaining portion 12 of the document holder 10 by inserting the at least one document through the opening 38 defined along the second retaining portion side edge 32 and into the compartment 20 of the retaining portion 12.

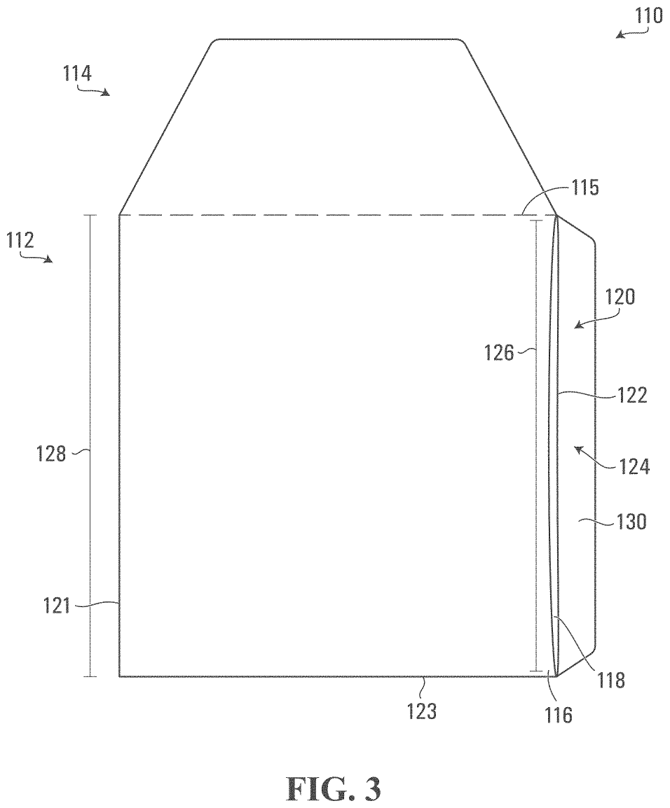

The window 100 may be adjusted to an open position, such that there is an opening 104 defined between a windowpane 106 of the window 100 and the vehicle 102. The document holder 10 may then be inserted into the opening 104 such that the retaining portion 12 remains within the vehicle 102 and the securing portion 14 is generally looped over an upper edge 108 of the windowpane 106. For example, if the user is a driver of the vehicle 102 and is sitting with in a cab of the vehicle 102, the user may insert the securing portion 14 of the document holder 10 from an internal side of the window 100 towards an external side of the window 100. On the other hand, if the user has exited the vehicle 102, the user may insert the retaining portion 12 of the document holder 10 from the external side of the window 100 into the internal side of the window 100. Retaining the at least one document on the internal side of the window 100 (inside the vehicle 102) inside the vehicle 102 rather than on the external side of the window 100 (outside the vehicle 102), can keep the at least one document safe from potential tampering, and also protects the at least one document from increment weather such as rain or snow. Retaining the at least one document within the vehicle 102 may also reduce the complexity and the costs associated with the manufacturing the document holder 10, as the document holder 10 may not require any extraneous feature (such as an optional flap portion described in greater detail below in association with FIG. 3) to protect the at least one document retained within the document holder 10.

In some embodiments, the document holder 10 may be inserted into the opening 104 such that the retaining portion 12 is located outside the vehicle 102. For example, the user may insert the retaining portion 12 of the document holder 10 from the internal side of the window 100 towards the external side of the window 100. Alternatively, if the user is outside of the vehicle 102, the user may insert the securing portion 14 of the document holder 10 from the external side of the window 100 towards the internal side of the window 100. Such embodiments where the retaining portion 12 is located outside of the vehicle 102 may be useful when the user is in a hurry and will return to the vehicle 102 quickly, or where the at least one document is a pamphlet for distribution, for example.

Although the securing portion 14 is the portion of the document holder 10 generally configured for engagement by the upper edge 108 of the windowpane 106, the user may insert the document holder 10 into the opening 104 such that a portion of the retaining portion 12 of the document holder 10 is looped over the upper edge 108 of the windowpane 106 instead and is the portion of the document holder 10 to be pinched by the upper edge 108 of the windowpane 106. This contributes to the functionality of the document holder 10 to be utilized in a haphazard manner to secure at least one document to the window 100 to allow the at least one document to be viewed and read by a viewer standing on an outside of the vehicle 102. As noted above, the document holder 10 which is still functional with such haphazard use may be beneficial to users, particularly when the user may be using the document holder 10 to display a document required to be displayed by a regulatory requirements, or which must be easily located in the cab of the vehicle 102 should the vehicle 102 be involved in an accident (such as a dangerous goods bill of lading for example), but the user is extremely tired, such as late at night, or after a long leg of a transport route. This functionality of the document holder 10 may be enabled by the simple construction of the document holder 10 in certain embodiments, whereby both the retaining portion 12 and the securing portion 14 are formed from the same first and second sheets 22, 24, such that there is little difference between the flexibility and thickness of the retaining portion 12 and securing portion 14.

Further, the user may insert the at least one document into the compartment 20 of the retaining portion 12 in a manner, or user may insert the securing portion 14 into the opening 104 in a manner, such that when the document holder 10 is secured into the window 100 as described below, a viewer on the outside of the vehicle 102 may be able to view and read the contents of the at least one document. In this respect, as noted above, the document holder 10 may be substantially reversible, with the first face 50 being substantially identical to the second face 52. This may allow the user to insert the at least one document in a haphazard manner and then adjust whether the first or second faces 50, 52 of the document holder 10 will face a viewer on the outside of the vehicle 102 allow the viewer to view and read the at least one document retained within the document holder 10.

After the document holder 10 is inserted into the opening 104, the window 100 may be adjusted from the open position to a closed position, such that the upper edge 108 of the windowpane 106 will pinch the document holder 10 (particularly the securing portion 14 of the document holder 10) between the windowpane 106 and the vehicle 102. The document holder 10 is thereby engaged to the window 100, with the retaining portion 12 retaining the at least one document on the internal side of the window 100 and the securing portion 14 substantially located on the external side of the window 100.

Referring to FIG. 3, another embodiment of a document holder is shown generally at 110. The document holder 110 is similar to the document holder 10 shown in FIG. 1, and includes a retaining portion 112 and a securing portion 114. The retaining portion 112 and the securing portion 114 maybe separated by a defining line 115. Also similar to the document holder 10, the document holder 110 may also be formed from a first sheet 116 and a second sheet 118 which comprise substantially transparent material.

In the embodiment shown in FIG. 3, the retaining portion 112 has a substantially rectangular shape. The retaining portion 12 includes a first retaining portion side edge 121, a second retaining portion side edge 122, a retaining portion bottom edge 123, wherein the defining line 115 generally defines a top edge of the retaining portion 112. The retaining portion 112 includes a compartment 120 for holding at least one document. The compartment 120 may be formed by the first and second sheets 116, 118 being joined at certain edges, including the first retaining portion side edge 121 and the defining line 115, to form the compartment 120. The retaining portion 112 also includes an opening 124 for receiving the at least one document in the compartment 120. The opening 124 maybe defined by the first and second sheets 116, 118 not being joined at the second retaining portion side edge 122. Similar to the opening 38 (shown in FIGS. 1 and 2), the opening 124 has a length 126 that is substantially equal to a maximum height 128 of the retaining portion 112, and is defined by the entire second retaining portion side edge 122.

In the embodiment shown in FIG. 3, the retaining portion 112 also includes a flap portion 130 extending proximate the opening 124, wherein the flap portion 130 is configured to cover the opening 124. In certain embodiments, the flap portion 130 may be formed by the second sheet 118 extending beyond the first sheets 116. In other embodiments, the flap portion 130 may be formed by the first sheet 116 extending beyond the second sheet 118. The flap portion 130 is configured to be folded over the opening 124 to close the opening 124, which may protect the at least one document retained within the compartment 120 when the document holder 110 is secured into a window such that the retaining portion 112 is located on an external side of the window (and outside a vehicle for example). The user may also insert the flap portion 130 into the opening 124, such as between the first and second sheets 116, 118, to more securely close the opening 124 and to maintain the flap portion 130 in the closed position.

In other embodiments (not shown), where a compartment in the retaining portion of a document holder comprises a slot having a first opening (such as the opening 124 shown in FIG. 3) proximate a first retaining portion side edge (not shown) and a second opening proximate a second retaining portion side edge (such as the first retaining portion side edge 121 shown in FIG. 3), the retaining portion may include two flap portions extending proximate the respective openings, wherein each flap portion is configured to cover a respective opening.

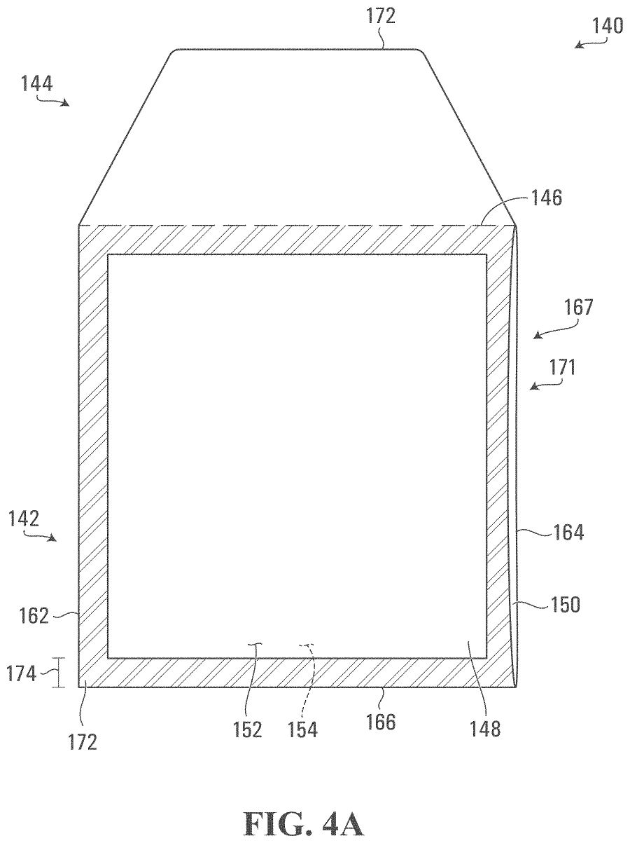

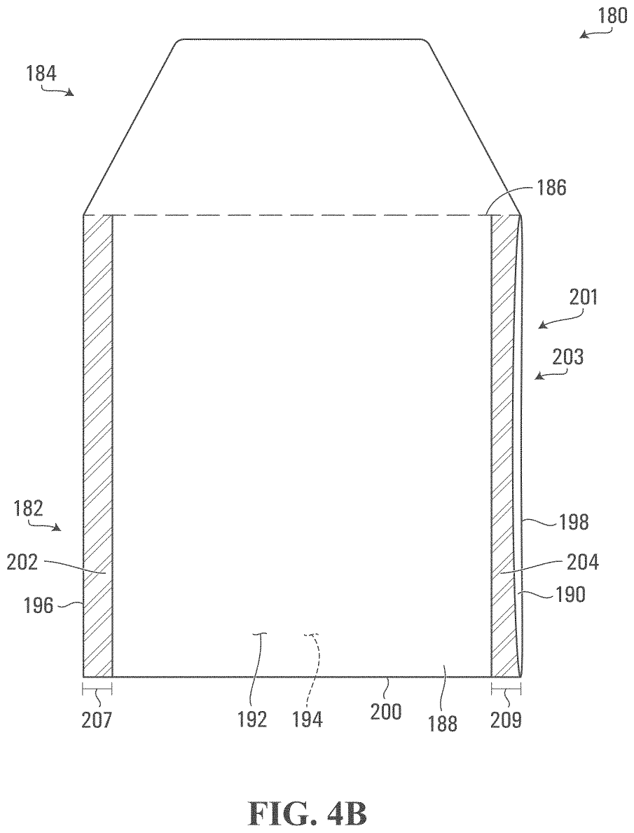

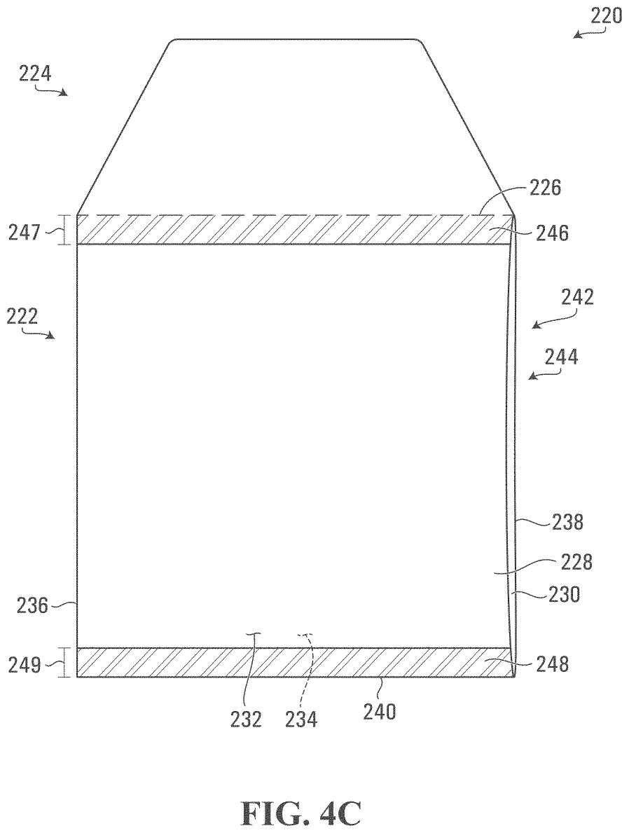

Referring now to FIGS. 4A to 4C, alternative embodiments of the document holder including at least one visibility element are described. Generally, a “visibility element” is an element attached to the document holder which allows a viewer on an external of the window (such as outside of vehicle for example) to better locate the document holder secured to the window, particularly at night, in a low light conditions, in adverse weather conditions, or in other poor visibility conditions. The at least one visibility element may also allow the document holder to be easily located in a cab of a vehicle by a user (such as an operator of the vehicle), particularly if the document holder is placed in a binder of numerous documents, or in other piles of numerous documents. In some embodiments, the visibility element maybe a brightly colored element adhered to or otherwise associated with the document holder, or may be a reflective element (such as a retroreflectors) adhered to or otherwise associated with the document holder. In other embodiments, the visibility element may be a portion or tab extending from the document holder formed of brightly colored or reflective plastic.

Referring first to FIG. 4A, an embodiment of a document holder including at least one visibility element is shown generally at 140. Similar to the document holder 10 shown in FIGS. 1 and 2, the document holder 140 includes a retaining portion 142 for retaining at least one document and a securing portion 144 for securing the document holder 140 to a window when the securing portion 144 is engaged by a windowpane of the window. The retaining portion 142 and the securing portion 144 and may be separated by a defining line 146. The document holder 140 may also be formed from a first sheet 148 and a second sheet 150 which comprise substantially transparent material, wherein the first sheet 148 may form a first face 152 of the document holder 140 and the second sheet 150 may form a second face 154 of the document holder 140.

The retaining portion 142 has a substantially rectangular shape. The retaining portion 142 further includes a first retaining portion side edge 162, a second retaining portion side edge 164, and a retaining portion bottom edge 166. The defining line 146 may form a top edge of the retaining portion 142. The retaining portion 142 also includes a compartment 167 for receiving the at least one document. The compartment 167 maybe a pocket formed by the first and second sheets 148, 150 being joined at specific locations, namely the first retaining portion side edge 162, the defining line 146 and the retaining portion bottom edge 166. The retaining portion 142 also includes an opening 171 for receiving the at least one document to be retained in the compartment 167. The opening 171 may be formed by the first and second sheets 148, 150 not being joined at certain locations, namely the second retaining portion side edge 164. The opening 171 may be defined by the entire second retaining portion side edge 164.

The securing portion 144 extends from the retaining portion 142 and in the embodiment shown in a FIG. 4A, has a trapezoidal shape and is similar to the securing portions described previously (including the securing portion 14 shown in FIGS. 1 and 2 and the securing portion 114 shown in FIG. 3 for example).

In the embodiment showing in FIG. 4A, the document holder 140 includes a visibility element border 172 adhered to the first face 152. The visibility element border 172 generally extends along a perimeter of the retaining portion 142 proximate the entire first retaining portion side edge 162, the entire retaining portion bottom edge 166, the entire second retaining portion side edge 164, and the entire defining line 146. The visibility element border 172 is generally dimensioned to not obstruct the clear viewing of the at least one document retained in the compartment 167. In this respect, the visibility element border 172 may have a maximum width 174 which is less than 1 inch for example. In other embodiments, the visibility element border 172 may have a maximum width which is less than 2 inches for example. Additionally, in the embodiment shown, only the first face 152 of the document holder 140 includes the visibility element border 172. However, in other embodiments, both the first face 152 and the second face 154 may include a respective visibility element border 172.

Referring now to FIG. 4B, another embodiment of a document holder including at least one visibility element is shown generally at 180. Similar to document holders described previously (such as the document holder 10 shown in FIGS. 1 and 2, and the document holder 140 shown in FIG. 4A), the document holder 180 also includes a retaining portion 182 and a securing portion 184, and wherein the retaining portion 182 and the securing portion 184 are separated by a defining line 186. The document holder 180 may be formed from a first sheet 188 and a second sheet 190 of substantially transparent material, wherein the first sheet 188 may define a first face 192 of the document holder 180, and the second sheet 190 may define a second face 194 of the document holder 180.

The retaining portion 182 has a substantially rectangular shape. The retaining portion 182 also includes a first retaining portion side edge 196, a second retaining portion side edge 198, and a retaining portion bottom edge 200. The defining line 186 generally defines a top edge of the retaining portion 182. The retaining portion 182 includes a compartment 201 for retaining at least one document. The compartment 201 may be formed by the first and second sheets 188, 190 being joined at the first retaining portion side edge 196, the retaining portion bottom edge 200 and the defining line 186. The retaining portion 182 also includes an opening 203 for receiving the at least one document into the compartment 201. The opening 203 may be formed by the first and second sheets 188, 190 not being joined at the second retaining portion side edge 198.

The securing portion 184 extends from the retaining portion 182 and in the embodiment shown in a FIG. 4B, has a trapezoidal shape and is similar to the securing portions described previously (including the securing portion 14 shown in FIGS. 1 and 2, the securing portion 114 shown in FIG. 3 and the securing portion 144 shown in FIG. 4A for example).

In the embodiment showing in FIG. 4B, the document holder 180 includes a first visibility element column 202 proximate the first retaining portion side edge 196, and a second visibility element column 204 proximate the second retaining portion side edge 198. The first and second visibility element columns 202, 204 are both adhered to or otherwise associated with the first face 192 of the document holder 180. The first and second visibility element columns 202, 204 may be dimensioned so as to not obstruct the ability of a viewer on an external side of the window to clearly view the at least one document received in the compartment 201 of the document holder 180. As such, the first visibility element column 202 may have a maximum width 207 which is less than approximately 1 inch, and similarly the second visibility element column 204 may have a maximum width 209 which is also less than approximately 1 inch. In other embodiments, the maximum widths 207, 209 may be less than approximately 2 inches for example. In the embodiment shown, only the first face 192 of the document holder 180 includes the first and second visibility element columns 202, 204. However, in other embodiments (not shown), both the first face 192 and the second face 194 and may include visibility element columns. In yet other embodiments, the first face 192 and the second face 194 may include visibility elements different from each other. For example, one of the first and second faces 192, 194 may include the first and second visibility element columns 202, 204, and the other one of the first and second faces 192, 194 may include a visibility element border (such as the visibility element border 172 shown in FIG. 4A above). Different visibility elements may be more suited to different visibility conditions. For example, the visibility element border 172 shown in FIG. 4A may provide a greater visibility when compared to the first and second visibility element columns 202, 204 shown in FIG. 4B, and may thus be better suited for adverse weather conditions. Alternatively, the different visibility elements may be made with different materials, such as materials suited for night-use like retroreflective elements versus materials suited for day-use like a brightly colored visibility elements. Having different visibility elements on different faces of a document holder may provide the document holder with greater functionality for use in a wide variety of weather conditions, and a user may insert the at least one document into the document holder or secure the document holder on a window, in accordance which visibility element is desired to be displayed to a viewer on the external side of the window.

Referring now to FIG. 4C, another embodiment of a document holder including at least one visibility element is shown generally at 220. Similar to the document holders described above (such as the document holder 10 shown in FIGS. 1 and 2, the document holder 140 shown in FIG. 4A, and the document holder 180 shown in FIG. 4B), the document holder 220 also includes a retaining portion 222 and a securing portion 224, wherein the retaining portion 222 and the securing portion 224 may be separated from each other by a defining line 226. The document holder 220 may be formed from a first sheet 228 and a second sheet 230 of substantially transparent material. The first sheet 228 may define a first face 232 of the document holder 220, and the second sheet 230 may define a second face 234 of the document holder 220.

The retaining portion 222 has a substantially rectangular shape. The retaining portion 222 further includes a first retaining portion side edge 236, a second retaining portion side edge 238, a retaining portion bottom edge 240, and wherein the defining line 226 generally defines a top edge of the retaining portion 222. The retaining portion 182 also includes a compartment 242 for retaining at least one document. The compartment 242 may be formed by the first and second sheets 228, 230 being joined at certain locations, namely the first retaining portion side edge 236, the retaining portion bottom edge 240 and the defining line 226. The retaining portion 222 also includes an opening 244 for receiving the at least one document into the compartment 242. The opening 244 may be formed by the first and second sheets 228, 230 not being joined at certain locations, namely the second retaining portion side edge 238, and maybe defined by the entire second retaining portion side edge 238.

In the embodiment showing in FIG. 4C, the document holder 220 includes a first visibility element row 246 proximate the defining line 226, and a second visibility element row 248 proximate the retaining portion bottom edge 240. The first and second visibility element rows 246, 248 are both adhered to, or otherwise associated with, the first face 232 of the document holder 220. The first and second visibility element rows 246, 248 may be the dimensioned to not obstruct the ability of a viewer on an external of a window to clearly view the at least one document received in the compartment 242 of the document holder 220. In the first visibility element row 246 may have a maximum width 247 which is less than one inch, and similarly the second visibility element row 248 may also have a maximum width 249 which is less than approximately 1 inch. In other embodiments, the maximum widths 247, 249 which may be less than approximately 2 inches. In the embodiment shown, only the first face 232 of the document holder 220 includes the first and second visibility element rows 246, 248. However, in other embodiments, both the first face 232 and the second face 234 may include visibility element rows. In yet other embodiments, the first face 232 and the second face 234 may include visibility elements which are different from each other. For example, one of the first and second faces 232, 234 includes one of the visibility element rows 246, 248, visibility element columns (similar to the visibility element columns 202, 204 shown in FIG. 4B), or visibility element borders (similar to the visibility element border 172 shown in FIG. 4A), and another one of the first and second faces 232, 234 includes another one of the visibility element rows 246, 248, the visibility element columns, or the visibility element border.

Referring briefly back to FIG. 2, in embodiments where the document holder includes at least one visibility element, (such as the document holder 140 shown in FIG. 4A, the document holder 180 shown in FIG. 4B, the document holder 220 shown in FIG. 4) such document holder may be secured to the window in such a manner that the at least one visibility element is visible to a viewer on the external side of the window 100.

For example, in the embodiment shown in FIGS. 4A, 4B and 4C, the visibility elements, including the visibility element border 172, the first and second visibility element columns 202, 204 and the first and second visibility element rows 246, 248, are only adhered to, or otherwise associated with, the first face of their respective document holders. The user may insert the at least one document into the document holder, or insert the securing portion of such document holders into an opening (such as the opening 104) defined by a windowpane (such as the windowpane 106) of a window (such as the window 100) in an open position, with an orientation such that when the document holder is secured to the window when the windowpane is adjusted to a substantially closed position, a viewer on the external side of the window may be able to view the at least one visibility element. In other embodiments (not shown), at least one visibility element may be adhered to, or otherwise associated with, both a first face and a second face of the document holder. In embodiments where the at least one visibility element adhered to the first and second faces of the document holder are identical such that the document holder is a fully reversible, the user may haphazardly insert the at least one document into the document holder, or secure the document holder to the window, and still have a viewer on the external of the window be able to view the at least one visibility element. This functionality may be beneficial when the user is extremely tired, such as late at night, or after a long leg of a transport route. In other embodiments, where the first and second at least one visibility element adhered to the first and second faces of the document holder are different, such that the at least one visibility element adhered to the first face is suited to different visibility conditions when compared to the at least one visibility element adhered to the second face, the user may insert the at least one document into the document holder, or secure the document holder to the window, in an orientation such that the appropriate at least one visibility element is displayed to a viewer on the external side of the window.

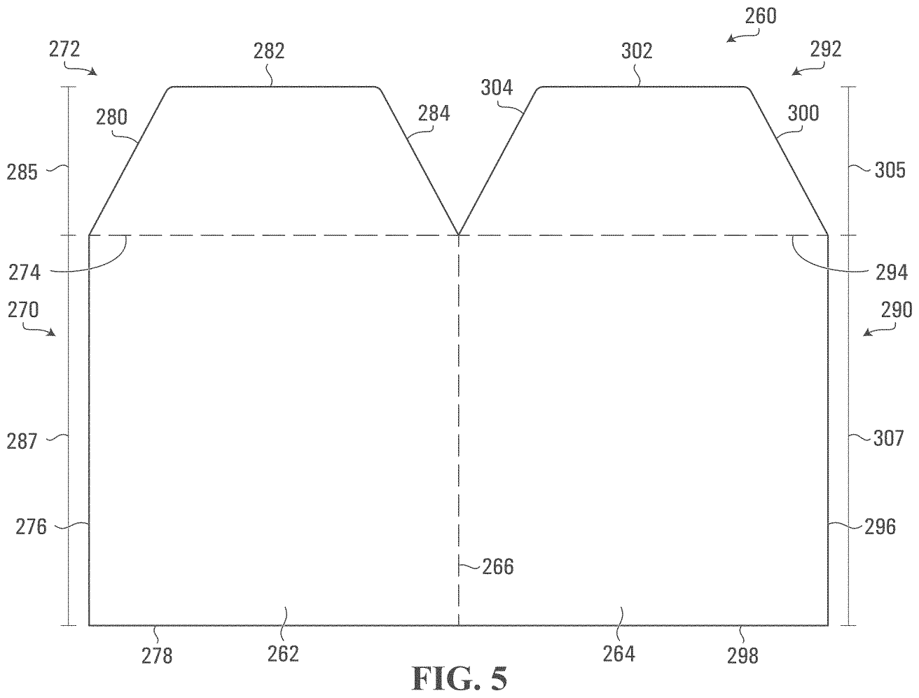

Referring to FIG. 5, a single unitary sheet having a pattern for forming a document holder (such as the document holder 10 shown in FIG. 1, the document holder 110 shown in FIG. 3, the document holder 140 shown in FIG. 4A, the document holder 180 shown in FIG. 4B, and the document holder 220 shown in FIG. 4C) is shown generally at 260. The single unitary sheet 260 may be formed from transparent material, such as clear, colored, and/or tinted plastic. The single unitary sheet 260 may include a first sheet portion 262 and a second sheet portion 264. The first and second sheet portions 262, 264 may be separated by a fold line 266.

The first sheet portion 262 may include a first retaining sheet portion 270 and a first securing sheet portion 272. The first retaining sheet portion 270 and the first securing sheet portion 272 may be separated by a defining line 274. The first retaining sheet portion 270 has a substantially rectangular shape, and the first retaining sheet portion 270 includes a first side edge 276 and a bottom edge 278. The fold line 266 may generally define the second side edge of the first retaining sheet portion 270, and the defining line 274 may define the upper edge of the first retaining sheet portion 270. The first securing sheet portion 272 has a substantially trapezoidal shape. The first securing sheet portion 272 includes a first side edge 280, a second side edge 284 and a top edge 282. The defining line 274 may generally define the bottom edge of the first securing sheet portion 272.

In the embodiment shown in FIG. 5, the second sheet portion 264 is a mirror image of the first sheet portion 262. In this respect, similar to the first sheet portion 262, the second sheet portion 264 includes a second retaining sheet portion 290 and a second securing sheet portion 292. The second retaining sheet portion 290 and the second securing sheet portion 292 may be separated by a defining line 294. The second retaining sheet portion 290 has a substantially rectangular shape, and includes a first side edge 296 and a bottom edge 298. The fold line 266 may generally define a second side edge of the second retaining sheet portion 290 and the defining line 294 may generally define an upper edge of the second retaining sheet portion 290. The second securing sheet portion 292 has a generally trapezoidal shape. The second securing sheet portion 292 includes a first side edge 300, a second side edge 304 and a top edge 302. The defining line 274 may generally define the bottom edge of the second securing sheet portion 292.

In other embodiments (not shown), the second sheet portion may not be a mirror image of the first sheet portion. For example, in embodiments where the securing portion of the document holder is only formed from one of a first sheet and a second sheet, one of the first and second sheet portions 262, 264 may not include one of the first and second securing sheet portions 292, 272. Additionally, in embodiments where the retaining portion of the document holder includes a flap portion (such the flap portion 130 of the document holder 110 shown in FIG. 3), one of the first and second retaining sheet portions 270, 290 may have an extension of material for forming the flap portion which is not present in the other one of the first and second retaining sheet portions 270, 290.

During manufacture of the document holder, the first sheet portion 262 may be folded over the second sheet portion 264 along the fold line 266 or vice versa. The first and second sheet portions 262, 264 may be joined at the defining lines 274, 294 to define a retaining portion of the document holder (comprising the first and second retaining sheet portions 270, 290) and a securing portion of the document holder (comprising the first and second securing sheet portions 272, 292). As noted previously, the first and second sheet portions 262, 264 may be joined using a variety of different methods, including by adhesive, stitching, or welding (including stitch welding).

As discussed above in association with FIG. 2, an eventual document holder formed by the single unitary sheet 260 may include a securing portion sized to be easily engaged by a windowpane of a window when the windowpane is adjusted from a open position to a substantially closed position. In this respect, the defining line 274 of the first sheet portion 262 may be positioned along a length of the first sheet portion 262 such that a maximum height 285 of the first securing sheet portion 272 (the distance between the defining line 274 and the top edge 282 of the first securing sheet portion 272) is at least one fourth of a maximum height 287 of the first retaining sheet portion 270 (the distance between the defining line 274 and the bottom edge 278 of the first retaining sheet portion 270). Similarly, the defining line 294 may be positioned along the length of the second sheet portion 264 such that a maximum height 305 of the second securing sheet portion 292 (the distance between the defining line 294 and the top edge 302) is at least one fourth of a maximum height 307 of the second retaining sheet portion 290 (the distance between the defining line 294 and the bottom edge 298). As such, when the first and second sheet portions 262, 264 are joined at the defining lines 274, 294, the securing portion of the eventual document holder (comprising the first and second securing sheet portions 272, 292) would have a maximum height that is at least one fourth of a maximum height of the retaining portion of the eventual document holder (comprising the first and second retaining sheet portions 270, 290). In other embodiments, the defining lines 274, 294 may be defined along the length of, respectively, the first and second sheet portions 262, 264 such that the maximum height of the first and second securing sheet portions 272, 292 may be at least one half of the maximum height of the first and second retaining sheet portions 270, 290. In such embodiments, when the first and second sheet portions 262, 264 are subsequently joined at the defining lines 274, 294, the securing portion of the eventual document holder would have a maximum height that is at least one half of a maximum height of the retaining portion of the eventual document holder.

Then, the bottom edge 278 of the first retaining sheet portion 270 may be joined to the bottom edge 298 of the second retaining sheet portion 290 to define a compartment of the retaining portion of the eventual document holder. In the embodiment shown in FIG. 5, the compartment is formed by a pocket sealed on three sides comprising the joined defining lines 274, 294, the fold line 266, and the joined bottom edges 278, 298 of the first and second retaining sheet portions 270, 290.

The side edges 276, 296 of the first and second retaining sheet portions 270, 290 may not be joined to define an opening for receiving at least one document to be retained in the compartment formed by the pocket. By not joining the side edges 276, 296 of the first and second retaining sheet portions 270, 290, an entire side edge of the retaining portion of will form the opening of the eventual document holder, and thus the opening will have a length that is substantially equal to the length of the side edges 276, 296 of the first and second retaining sheet portions 270, 290. Additionally, by not requiring any portion of the side edges 276, 296 to be joined, the complexity and cost for manufacturing the document holder may be reduced, as the opening and the compartment of the eventual document holder would be defined by joining only two locations of the first and second sheet portions 262, 264, namely along the defining lines 274, 294 and the bottom edges 278, 298, without the need for any further joining of the first and second sheet portions 262, 264.

Then, the first side edges 280, 300, the second side edges 284, 304, and the top edges 282, 302 of the first and second securing sheet portions 272, 292 may be joined to generally form the securing portion of the eventual document holder. Accordingly, in the embodiment shown in FIG. 5, a document holder maybe manufactured from the single unitary sheet 260. This may allow the document holder to be cheaply and easily manufactured when compared to more complex document holders.

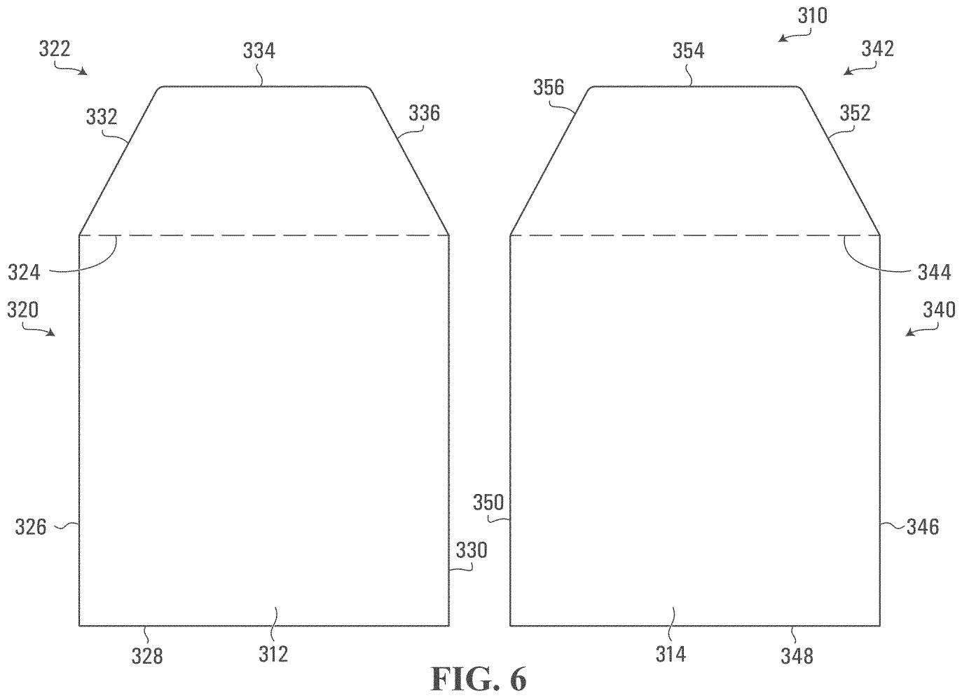

Referring now to FIG. 6, a system comprising separate sheet portions for forming a document holder described above (such as the document holder 10 shown in FIG. 1, the document holder 110 shown in FIG. 3, the document holder 140 shown in FIG. 4A, the document holder 180 shown in FIG. 4B, and the document holder 220 shown in FIG. 4C) is shown generally at 310. The system 310 includes a first sheet portion 312 and a separate second sheet portion 314. The first and second sheet portions 312, 314 may be formed from a transparent material, such as clear, coloured, and/or tinted plastic.

The first sheet portion 312 includes a first retaining sheet portion 320 and a first securing sheet portion 322, wherein the first retaining and securing sheet portions 320 and 322 are separated by a defining line 324. The first retaining sheet portion 320 has a substantially rectangular shape and includes a first side edge 326, a bottom edge 328, and a second side edge 330, wherein the defining line 324 generally defines the top edge of the first retaining sheet portion 320. The first securing sheet portion 322 has a substantially trapezoidal shape, and includes a first side edge 332, a top edge 334, and a second side edge 336, wherein the defining line 324 generally defines a bottom edge of the first securing sheet portion 322.

In the embodiment shown in FIG. 6, the second sheet portion 314 is a mirror image of the first sheet portion of 312. In this respect, the second sheet portion 314 includes a second retaining sheet portion 340 and a second securing sheet portion 342, wherein the retaining and securing sheet portions 340, 342 are separated by a defining line 344. The second retaining sheet portion 340 has a substantially rectangular shape and includes a first side edge 346, a bottom edge 348 and a second side edge 350, wherein the defining line 344 generally defines a top edge of the second retaining sheet portion 340. The second securing sheet portion 342 has a substantially trapezoidal shape and includes a first side edge 352, a top edge 354, and a second side edge 356, wherein the defining line 344 generally defines a bottom edge of the second securing sheet portion 342.

Similar to the single unitary sheet 260 shown in FIG. 5, in other embodiments (not shown) the first sheet portion 312 and the second sheet portion 314 may not be a mirror image of each other, such as in embodiments where one of the first and second sheet portions 312, 314 has an additional extension of material for forming a flap portion, or a tab, which is not present in the other one of the first and second sheet portions 312, 314, or when the securing portion of the eventual document holder is only formed from one of the first and second sheet portions 312, 314.

During manufacture of the document holder, the first sheet portion 312 maybe overlain the second sheet portion 314 or vice versa. The first and second sheet portions 312, 314 may then be joined at the defining lines 324, 344 to define a retaining portion of the document holder (comprising the first and second retaining sheet portions 320, 340) and a securing portion of the document holder (comprising the first and second securing sheet portions 322, 342).

Similar to the single unitary sheet 260 shown in FIG. 5, the defining line 324 may be defined along the length of the first sheet portion 312 such that a maximum height of the first securing sheet portion 322 (the distance between the defining line 324 and the top edge 334) is at least one fourth of, and may be at least one half of, a maximum height of the first retaining sheet portion 320 (the distance between the defining line 324 and the bottom edge 328). Similarly, the defining line 344 may be defined along the length of the second sheet portion 314 such that a maximum height of the second securing sheet portion 342 (the distance between the defining line 344 and the top edge 354) is at least one fourth of, and may be at least one half of, a maximum height of the second retaining sheet portion 340 (the distance between the defining line 344 and the bottom edge 348). As such, when the first and second sheet portions 312, 314 are joined at the defining lines 324, 344, the securing portion of the eventual document holder (comprising the first and second securing sheet portions 322, 342) would have a maximum height that is at least one fourth, or at least half, a maximum height of the retaining portion of the eventual document holder (comprising the first and the second retaining sheet portions 320, 340)

Then, the bottom edge 328 of the first retaining sheet portion 320 maybe joined to the bottom edge 348 of the second retaining sheet portion 340 to define the retaining portion of the eventual document holder. In some embodiments, the first side edge 326 of the first retaining sheet portion 320 may also be joined to the first side edge 346 of the second retaining sheet portion 340, to generally define a compartment of the retaining portion of the eventual document holder. In this respect, the compartment of the document holder formed by the first and second sheet portions 312, 314 may be formed by a pocket sealed on three sides, namely the joined defining lines 324, 344, the joined first side edges 326, 346, and the joined bottom edges 328, 348 of the first and second retaining sheet portions 320, 340. The second side edge 330 of the first retaining sheet portion 320 is not joined to the second side edge 350 of the second retaining sheet portion 340 to define an opening for receiving at least one document to be retained in the compartment of the eventual document holder. By not joining any part of the secondside edges 330, 350 of the first and second retaining sheet portions 320, 340, an entire side edge of the retaining portion of the eventual document holder formed from the system 310 will form the opening. In other embodiments, the first side edges 326, 346 of the first and second retaining sheet portions 320, 340 may not be joined to define a first opening, and the second side edges 330, 350 of the first and second retaining sheet portions 320, 340 may also not being joined to define a second opening, wherein the first and second openings form a through hole. In such embodiments, the compartment of the document holder is a slot having the through hole and is sealed only sealed on two sides, namely the joined defining lines 324, 344 and the joined bottom edges 328, 348.

Then, the first side edges 332, 352, the top edges 334, 354 and the second side edges 336, 356 of the first and second securing sheet portions 322, 342 may be joined to generally form a securing portion of the eventual document holder.

Referring briefly now to both FIGS. 5 and 6, after the eventual document holder is formed utilizing either the single unitary sheet 260 of FIG. 5 or the system 310 comprising a first sheet portion 312 and a separate second sheet portion 314 shown in FIG. 6, at least one visibility element may be attached to a first face or a second face of the eventual document holder, such as via an adhesive, or stitching, or other like method. The at least one visibility element may be one or more of a visibility element border (such as the visibility element border 172 shown in FIG. 4A), visibility element columns (such as the visibility element columns 202, 204 shown in FIG. 4B), and visibility element rows (such as the visibility element rows 246, 248 shown in FIG. 4C). In some other embodiments, the at least one visibility element may be attached to the first and second sheet portions (such as the first and second sheet portions 262, 264 shown in FIG. 5 or the first and second sheet portions 312, 314 shown in FIG. 6 for example), before the first and the second sheet portions are joined to form the eventual document holder.

Referring now to FIGS. 7A to 7B, alternative embodiments of the document holder having an irregular shape or an unusual shape will now be described. Generally, an “irregular shape” or an “unusual shape” are shapes which do not correspond to a shape of the at least one document to be retained by the document holder, and may include shapes which include non-linear edges. Having an irregularly or an unusually shaped document holder may allow the document holder to be easily located in a cab of a vehicle by a user, particularly if the document holder is placed in a binder of numerous documents, or other pile of numerous documents.

Referring first to FIG. 7A, a document holder having an irregular shape is generally shown at 360. Similar to the document holders described previously (such as the document holder 10 shown in FIGS. 1 and 2, the document holder 110 shown in FIG. 3, the document holder 140 shown in FIG. 4A, the document holder 180 shown in FIG. 4B, and the document holder 220 shown in FIG. 4C), the document holder 360 also includes a retaining portion 362 and a securing portion 364, wherein the retaining and securing portions 362, 364 are separated by a defining line 366. Additionally, similar to the document holders described previously, document holder 360 may be formed from a first sheet 359 and a second sheet 361 of substantially transparent material, wherein the first sheet 359 forms a first face 363 of the document holder 360 and the second sheet 361 forms a second face 365 of the document holder 360. In certain embodiments, the first sheet 359 and the second sheet 361 are separate sheets having a generally rectangular shape with a irregular side edge, such that the document holder 360 is formed from separate sheets similar to the system 310 comprising the separate sheet portions 312, 314 shown in FIG. 6. In other embodiments, the first sheet 359 and the second sheet 361 maybe first and second sheet portions of a single unitary sheet separated by a fold line which forms a first retaining portion side edge 370, similar to the single unitary sheet 260 shown in FIG. 5.

The retaining portion 362 is generally rectangular, but includes an irregularly shaped side edge. The retaining portion 362 includes the first retaining portion side edge 370, a retaining portion bottom edge 372, and a second retaining portion side edge 374, wherein the defining line 366 generally defines a top edge of the retaining portion 362. The first retaining portion side edge 370 is substantially linear, but the second retaining portion side edge 374 is non-linear and forms the irregularly shaped side edge. In the embodiment shown in FIG. 7A, the non-linear second retaining portion side edge 374 has a sine wave form. However, in other embodiments, the non-linear second retaining portion side edge 374 may have other non-linear shapes, including a square waveform, a triangular waveform, a sawtooth wave form, or may be a curved edge or may be an edge including a tab.

The retaining portion 362 includes a compartment 376 for retaining at least one document. The compartment 376 may be a pocket formed by the first and second sheets 359, 361 being joined at specific locations, namely the first retaining portion side edge 370, the retaining portion bottom edge 372 and the defining line 366. The retaining portion 362 also includes an opening 378 for receiving at least one document to be retained in the compartment 376. The opening 378 may be formed by the first and second sheets 359, 361 not being joined at (or proximate to) the non-linear second retaining portion side edge 374, and maybe defined by the entire non-linear second retaining portion side edge 374. The opening 378 also has a maximum height 380 which is substantially equal to a maximum height of the retaining portion 362 (being the distance between the defining line 366 and the retaining portion bottom edge 372). In other embodiments (not shown), the compartment 376 may be a slot having a through hole formed by the first and second sheets 359, 361 being only joined at the retaining portion bottom edge 372 and the defining line 366. In such embodiments, the retaining portion 362 may have a first opening proximate the first retaining portion side edge 370 and a second opening proximate the non-linear second retaining portion side edge 374 defined by the first and second sheets 359, 361 not being joined at the first retaining portion side edge 370 and not being joined at the non-linear second retaining portion side edge 374.

The securing portion 364 extends from the retaining portion 362 and in the embodiment shown in FIG. 7A, has a trapezoidal shape and is similar to the securing portions described previously (including the securing portion 14 shown in FIG. 1, the securing portion 114 shown in FIG. 3, the securing portion 144 shown in FIG. 4A, the securing portion 184 shown in FIG. 4B, and the securing portion 224 shown in FIG. 4C).

The securing portion 364 has a maximum height 381 (generally the distance between the defining line 366 and a top edge of the securing portion 364) and the retaining portion 362 also has a maximum height 383 (generally the distance between the defining line 366 and the retaining portion bottom edge 372). In the embodiment shown in FIG. 7B, the maximum height 381 of the securing portion 364 is at least one fourth of the maximum height 383 of the retaining portion 362, which may allow the securing portion 364 to be easily engaged by a windowpane of a window adjusted to a closed position. In other embodiments (not shown), the maximum height 381 of the securing portion 364 may be at least one half the maximum height 383 of the retaining portion 362.

In certain embodiments (not shown), the document holder 360 may include at least one visibility element adhered to, or otherwise associated with, at least one of the first and second faces 363, 365. The at least one visibility element may be a visibility element border similar to the visibility element border 172 shown in FIG. 4A, which generally extends along a perimeter of the retaining portion 362 proximate the entire first retaining portion side edge 370, the entire retaining portion bottom edge 372, the entire non-linear second retaining portion side edge 374 and the entire defining line 366. However, unlike the visibility element border 172 shown in FIG. 4A, the portion of the visibility element border adhered to the document holder 360 proximate to the non-linear second retaining portion side edge 374 may have an irregular shape corresponding to the irregular shape of the non-linear second retaining portion side edge 374. As such, the portion of the visibility element border proximate to the non-linear second retaining portion side edge 374 may also have a sine wave form. In other embodiments, the at least one visibility element maybe visibility element columns similar to the visibility element columns 202, 204 shown in FIG. 4B, with a first visibility element column located proximate the first retaining portion side edge 370 and a second visibility element column located proximate the non-linear second retaining portion side edge 374. Similar to the visibility element border noted above, the second visibility element column located proximate the non-linear second retaining portion side edge 374 may have an irregular column shape corresponding to the irregular and non-linear shape of the non-linear second retaining portion side edge 374, and may be a column having a sine wave form along a height of the column. In other embodiments, the at least one visibility element may be visibility element rows similar to the visibility element rows 246 and 248 shown in FIG. 4C, with a first visibility element row located proximate the defining line 366 and a second visibility elemental role located proximate the retaining portion bottom edge 372.

Referring now to FIG. 7B, a document holder having a triangular shape is shown generally at 390. The document holder 390 includes a retaining portion 392 and a securing portion 394 extending from the retaining portion 392, wherein the retaining and the securing portions 392, 394 are separated by a defining line 396.

Similar to the document holders described previously (such as the document holder 10 shown in FIGS. 1 and 2, the document holder 110 shown in FIG. 3, the document holder 140 shown in FIG. 4A, the document holder 180 shown in FIG. 4B, the document holder 220 shown in FIG. 4C, and the document holder 360 shown in FIG. 7A), the document holder 390 may be formed from a first sheet 398 and a second sheet 399 of substantially transparent material. The first sheet 398 may form a first face 400 of the document holder 390 and the second sheet 399 may form a second face 401 of the document holder 390. In certain embodiments, the first sheet 398 and the second sheet 399 are separate sheets having a generally triangular shape, such that document holder 390 is formed from separate sheets portions similar to the system 310 comprising the separate sheet portions 312, 314 shown in FIG. 6. In other embodiments, the first and second sheets 398, 399 may be first and second sheet portions of a single unitary sheet separated by a fold line, such that the document holder 390 may be formed from the single unitary sheet wherein a first securing portion side edge 412 and a first retaining portion side edge 402 are defined by the fold line, similar to the single unitary sheet 260 shown in FIG. 5.

As the document holder 390 has a generally triangular shape, the retaining portion 392 has a generally trapezoidal shape which comprises a bottom portion of the triangle of the document holder 390, and generally includes the first retaining portion side edge 402, a retaining portion bottom edge 403 and a second retaining portion side edge 404, wherein the defining line 396 generally defines a top edge of the retaining portion 392. The retaining portion 392 also includes a compartment 408 for retaining at least one document. The compartment 408 may be a pocket formed by the first and second sheets 398, 399 being joined at specific locations, namely at the first retaining portion side edge 402, the retaining portion bottom edge 403 and the defining line 396. The retaining portion 392 also includes an opening 409 for receiving at least one document to be retained in the compartment 408. The opening 409 may be formed by the first and second sheets 398, 399 not being joined at the second retaining portion side edge 404. The opening 409 may have a length 410 that is defined by the entire second retaining portion side edge 404, and thus the length 410 of the opening 409 maybe substantially equal to the length of the second retaining portion side edge 404. In other embodiments, the compartment 408 may be a slot having a through hole formed by the first and second sheets 398, 399 being only joined at the retaining portion bottom edge 403 and the defining line 396. In such embodiments, the retaining portion 392 may have a first opening proximate the first retaining portion side edge 402 and a second opening proximate the second retaining portion side edge 404 defined by the first and second sheets 398, 399 not being joined at the first retaining portion side edge 402 and not being joined at the second retaining portion side edge 404.

The securing portion 394 extends from the retaining portion 392, and in the embodiment shown in FIG. 7B, has a generally triangular shape comprising a top portion of the triangle of the document holder 390. The securing portion 394 includes the first securing portion side edge 412 and a second securing portion side edge 413 joining at an apex 417, wherein the defining line 396 generally defines a bottom edge of the securing portion 394. The securing portion 394 may be formed by the first and second sheets 398, 399 being joined at certain locations, specifically at the defining line 396, the first securing portion side edge 412 and the second securing portion side edge 413. However, in other embodiments, the securing portion 394 may be formed from a single one of the first and second sheets 398, 399, as generally described above.

The securing portion 394 has a maximum height 414 (generally the distance between the defining line 396 and the apex 417) and the retaining portion 392 also has a maximum height 415 (generally the distance between the defining line 396 and the retaining portion bottom edge 403). In the embodiment shown in FIG. 7B, the maximum height 414 of the securing portion 394 is at least fourth of the maximum height 415 of the retaining portion 392, which may allow the securing portion 394 to be easily engaged by a windowpane of a window adjusted to a closed position. In other embodiments (not shown), the maximum height 414 of the securing portion 394 maybe at least one half the maximum height 415 of the retaining portion 392.

In certain embodiments (not shown), the document holder 390 may include at least one visibility element adhered to, or otherwise associated with, at least one of the first and second faces 400, 401. The at least one visibility element may be a visibility element border similar to the visibility element border 172 shown in FIG. 4A, and which generally extends along a perimeter of the retaining portion 392, proximate the entire first retaining portion side edge 402, proximate the entire retaining portion bottom edge 403, proximate the entire second retaining portion side edge 404 and proximate the entire defining line 396, to form a generally trapezoidal visibility element border. In other embodiments (not shown), the at least one visibility element maybe first and second visibility element columns similar to the first and second visibility element columns 202, 204 shown in FIG. 4B, with a first visibility element column located proximate to the first retaining portion side edge 402 and a second visibility element column located proximate the second retaining portion side edge 404. However, unlike the first and second visibility element columns 202, 204 shown in FIG. 4B which are positioned perpendicular to the retaining portion bottom edge 200 (as the retaining portion 182 of the document holder 180 has a substantially rectangular shape), the first and second visibility element columns located proximate the first and second retaining portion side edges 402, 404 may be positioned at an acute angle relative to the retaining portion bottom edge 403 (as the retaining portion 392 forms a bottom portion of the document holder 390 having a generally triangular shape). In other embodiments (not shown), the at least one visibility element may be visibility element rows similar to the first and second visibility element rows 246, 248 shown in FIG. 4C, with a first visibility element row located proximate to the defining line 396 and a second visibility element row located proximate to the retaining portion bottom edge 403.

Referring now to FIG. 7C, a document holder having a circular shape is generally shown at 420. The document holder 420 includes a retaining portion 422 and a securing portion 424 extending from the retaining portion 422, wherein the retaining portion 422 and the securing portion 424 are separated by a defining line 426.

Similar to the document holders described previously (such as the document holder 10 shown in FIGS. 1 and 2, the document holder 110 shown in FIG. 3, the document holder 140 shown in FIG. 4A, the document holder 180 shown in FIG. 4B, and the document holder 220 shown in FIG. 4C, the document holder 360 shown in FIG. 7A, and the document holder 390 shown in FIG. 7B), the document holder 420 may be formed from a first sheet 428 and a second sheet 430 of substantially transparent material. The first sheet 428 may form a first face 432 of the document holder 420, and the second sheet 430 may form a second face 434 of the document holder 420. In certain embodiments, the first sheet 428 and the second sheet 430 are separate sheets having a generally circular shape, such that the document holder 420 is formed from separate sheets similar to the system 310 comprising the separate sheet portions 312, 314 shown in FIG. 6.

As the document holder 420 has a generally circular shape, the document holder 420 has a circumference 436. The retaining portion 422 is generally a semi-circular half portion of the circular document holder 420, and includes a first side portion of the circumference 440, a bottom portion of the circumference 442, and a second side portion of the circumference 444, wherein the defining line 426 generally defines a top edge of the retaining portion 422. The retaining portion 422 includes a compartment 446 for retaining at least one document. The compartment 446 may be a pocket formed by the first and second sheets 428, 430 being joined at specific locations, namely at the first side portion of the circumference 440, the bottom portion of the circumference 442 and the defining line 426. The retaining portion 422 also includes an opening 448 for receiving at least one document to be retained in the compartment 446. The opening 448 may be formed by the first and second sheets 428, 430 not being joined at the second side portion of the circumference 444. The opening 448 may have a length that is defined by the entire second side portion of the circumference 444.

The securing portion 424 extends from the retaining portion 422, and in the embodiment shown in FIG. 7C, also has a generally semi-circular shape. The securing portion 424 includes an upper portion of the circumference 438, wherein the defining line 426 generally defines a bottom edge of the securing portion 424. The securing portion 424 may be formed by the first and second sheets 428, 430 being joined at certain locations, specifically along the upper portion of the circumference 438 and the defining line 426. However, in other embodiments, the securing portion 424 may be formed from a single one of the first and second sheets 428, 430, such as when one of the first and second sheets 428, 430 includes additional material for forming the securing portion 424, but the other one of the first and second sheets 428, 430 only includes the retaining portion 422 and stops at the defining line 426.

The securing portion 424 has a maximum height 450 (generally the distance from the defining line 426 to a highest point of the upper portion of the circumference 438) and the retaining portion 422 also has a maximum height 452 (generally the distance from the defining line 426 to a lowest point of the bottom portion of the circumference 442). In the embodiment shown in FIG. 7C, the maximum height 450 of the securing portion 424 maybe at least one fourth of the maximum height 452 of the retaining portion 422. In other embodiments (not shown), the maximum height 450 of the securing portion 424 maybe at least one half of the maximum height 452 of the retaining portion 422.

In certain embodiments (not shown), the document holder 420 may include at least one visibility element adhered to, or otherwise associated with, at least one of the first and second faces 432, 434. The at least one visibility element maybe a visibility element border similar to the visibility element border 172 shown in FIG. 4A, which generally extends along a perimeter of the retaining portion 422, such as proximate the entire first side portion of the circumference 440, the entire bottom portion of the circumference 442, the entire second side portion of the circumference 444, and the defining line 396. However, unlike the visibility element border 172 (shown in FIG. 4A) which is substantially linear, the visibility element border adhered to the document holder 420 may have curved portions to generally correspond to the curved shape of the circumference 436. Specifically, the visibility element border adhered to the document holder 420 proximate the first side portion of the circumference 440, proximate the bottom portion of the circumference 442 and proximate the second side portion of the circumference 444 may be curved.

Generally, the embodiments of document holders for securing at least one document to a window of a vehicle include features which allow such document holders to be more easily and haphazardly used. For example, document holders having an opening with a length that is defined by an entire side edge of a retaining portion of the document holder, or which has a length that is substantially similar to the maximum height of the retaining portion of the document holder, can allow a user (such as a driver of a vehicle) to easily insert and remove any document retained within the retaining portion of the document holder. Such ease of insertion and removal of documents may allow the document holder to provide greater functionality for users that need to display certain documents with the vehicle, but where such documents may frequently change depending on the goods currently being carried by the vehicle, such as dangerous goods bills of lading, for example.

Additionally, the embodiments of document holders which include an irregular or an unusual shape may allow the document holder, and the document retained by the document holder, to be more easily located by the user in a messy cab of a vehicle, such as in a binder of numerous documents or other pile of numerous documents. This may encourage the user to regularly display the document retained by the document holder, especially when the user may be extremely tired, such as late at night or after a long leg of a transport route. Similarly, the embodiments of document holders which include at least one visibility element adhered to at least one face of the document holder may also allow the document holder to be more easily located by the user in a messy cab of a vehicle, particularly at night-time or in other low light conditions for example. Document holders which include at least one visibility element may also be easily located by a viewer on an external side of a window of a vehicle when the document holder is secured to the window, particularly at night, in low light conditions, in adverse weather conditions or in other poor visibility conditions.

Finally, the embodiment of document holders which are formed from a single unitary sheet may allow the document holder to be cheaply and easily manufactured when compared to more complex document holders. Further, as the embodiments of the document holder described above is generally adapted to be positioned on an internal side of a window, the embodiments of the document holder may be relatively uncomplicated in construction, as such document holders would not require any additional features to protect the at least one document retained by the document holder from adverse weather conditions.

While specific embodiments have been described and illustrated, such embodiments should be considered illustrative of the subject matter described herein and not as limiting the claims as construed in accordance with the relevant jurisprudence.

We claim:

1. A method of securing at least one document to a window, the method comprising:
retaining the at least one document in a retaining portion of a document holder by inserting the at least one document through an opening defined along a retaining portion side edge of the retaining portion, wherein a length of the opening is substantially equal to a length of the retaining portion side edge;
inserting a securing portion of the document holder extending from the retaining portion into an opening defined by a windowpane of the window when the windowpane is in an open position; and
when the securing portion is inserted into the opening defined by the windowpane, moving the windowpane from the open position to a substantially closed position to engage the securing portion and thereby secure the document holder at the window.

2. The method of claim 1, wherein, when the document holder is secured at the window, the retaining portion is positioned on an outer side of the window.

3. The method of claim 1, wherein, when the document holder is secured at the window, the retaining portion is positioned on an inner side of the window.

4. The method of claim 1, wherein, when the document holder is secured at the window, at least one visibility element of the document holder is visible to a person on an outer side of the window.

5. A document holder comprising:
a retaining portion for retaining at least one document, the retaining portion including a first retaining portion side edge, a second retaining portion side edge, and an opening defined along at least one of the first and second retaining portion side edges, wherein a length of the opening is substantially equal to a length of the at least one first and second retaining portion side edges; and
a securing portion extending from the retaining portion, the securing portion configured to secure the document retainer to a window when engaged by a windowpane of the window when the windowpane is in a substantially closed position.

6. The document holder of claim 5, wherein the document holder is configured to be engaged by the windowpane to position the retaining portion on an outer side of the window.

7. The document holder of claim 5, wherein the document holder is configured to be engaged by the windowpane to position the retaining portion on an inner side of the window.

8. The document holder of claim 5, further comprising at least one visibility element on at least one of a first face and a second face of the document holder.

9. The document holder of claim 5, wherein a maximum height of the securing portion is at least one fourth of a maximum height of the retaining portion.

10. The document holder of claim 5, wherein the document holder has an irregular shape.

11. The document holder of claim 5, wherein the document holder has a substantially circular shape.

12. The document holder of claim 5, wherein the document holder has a substantially triangular shape.

13. A method of manufacturing a document holder from a first sheet and a second sheet, the method comprising:
joining the first and second sheets at a defining line to define a securing portion of the document holder on a first side of the defining line and a retaining portion of the document holder on a second side of the defining line;
forming the securing portion by joining the first and second sheet portions proximate a securing portion edge; and
forming the retaining portion by joining the first and second sheet portions proximate a retaining portion bottom edge and not joining the first and second sheet portions proximate at least one of a first retaining portion side edge and a second retaining portion side edge to form an opening in the retaining portion, wherein a length of the opening is substantially equal to a length of the at least one of the first and second retaining portion side edges.

14. The method of claim 13, wherein forming the retaining portion comprises not joining the first and second sheet portions proximate the first retaining portion side edge and the second retaining portion side edge to form a through opening in the retaining portion.

15. The method of claim 13, wherein the first and second sheet portions are portions of one unitary sheet.

16. The method of claim 15, further comprising:
prior to joining the first and second sheet portions at the defining line, folding the unitary sheet along a fold line to define one of the first and second retaining portion side edges.

17. The method of claim 13, wherein the first and second sheet portions comprise separate first and second sheets.

18. The method of claim 13, further comprising attaching at least one visibility element to a face of the document holder.

19. The method of claim 13, wherein joining the first and second sheet portions at the defining line comprises joining the first and second sheet portions at a defining line positioned such that a maximum height of the securing portion is at least one fourth of a maximum height of the retaining portion.
